(19) United States
(12) Patent Application Publication
(10) Pub. No.: US 2008/0104762 A1
(43) Pub. Date: May 8, 2008

(54) TRANSFER MATTRESS WITH DEVICE PORTAL

(75) Inventor: DAVID T. DAVIS, Bethlehem, PA (US)

Correspondence Address: DUANE MORRIS LLP;IP DEPARTMENT, 30 SOUTH 17TH STREET, PHILADELPHIA, PA, 19103-4196, US

(73) Assignee: WOODLARK CIRCLE, INC., BETHLEHEM, PA (US)

(21) Appl. No.: 11/555,701

(22) Filed: Nov. 2, 2006

(51) Int. Cl. A61G 7/00

(52) U.S. Cl. 5/621

(57) ABSTRACT

An inflatable mattress having a top panel including an annular internal edge that defines a first opening and a bottom panel sealingly assembled to the top panel and having an annular internal edge that defines a second opening. The bottom panel also includes a plurality of perforations wherein the first opening and the second opening together form a portal for accommodating a medical device protruding from a patient. A dual-chambered transfer mattress is also provided having a blind portal defined through a top inflatable mattress. Methods are provided for holding a patient for a period of time where the patient has had a medical fixture implanted in a body portion so that a portion of the medical fixture projects outwardly from the patient's body and is located within the portal the portal provides clearance for accommodating the medical fixture.

### FIELD OF THE INVENTION

The present invention generally relates to air mattresses, and more particularly to air mattresses that accommodate surgical fixtures and instruments that may protrude from or be attached to a patient's body while that person reclines on the mattress.

### BACKGROUND OF THE INVENTION

It is a well known procedure in the medical arts to have a portion of a medical instrument or fixture remain in the patient's body temporarily. In some instances, that fixture may extend from a portion of the patient's body for a time. For example, brachytherapy is a general term covering medical treatment which involves placement of a radioactive source near a diseased tissue and may involve the temporary or permanent implantation or insertion of a radioactive source into the body of a patient. The radioactive source is normally located in proximity to the area of the body which is being treated. This has the advantage that a high dose of radiation may be delivered to the treatment site with relatively low dosages of radiation to surrounding or intervening healthy tissue.

One technique for implanting the so-called radioactive “seeds” involves manually loading the seeds, one by one, into hollow brachytherapy needles along with spacers in the order prescribed by the treatment plan. The physician then inserts a loaded brachytherapy needle into a specific area of tissue to be treated. A pushrod is guided into the channel of the brachytherapy needle. The physician withdraws the brachytherapy needle while holding the pushrod in place. In the case of prostate cancer treatment by brachytherapy, the radioactive seeds are placed inside thin, hollow needles, which are inserted through the skin of the perineum (area between the scrotum and anus) into the prostate where the seeds and the needles may remain for several hours. One significant problem resulting from this mode of treatment is the difficulty associated with the patient lying on his back for several hours with several needles extending outwardly from his perineum. Very often, conventional mattresses and gurneys will not easily accommodate a patient in this situation without contacting the needles and either disturbing their location or causing discomfort to the patient. Similar needs arise in the context of orthopedic procedures and devices often used with correction or reconstruction of the spine, knee, or shoulder.

Patient handling mattresses are known in the art which include at least two flexible material sheets, that together define a plenum chamber, with at least one sheet being perforated with small pinholes over at least a central surface area, and which open up directly to the interior of the plenum chamber. Such prior art mattresses are used by arranging the perforated sheet so that it faces an underlying fixed, generally planar support surface, such as a floor or table. When the mattress is charged with pressurized air, the escape of air under pressure through the pinholes acts initially to jack a load placed upon the mattress above the perforated flexible sheet, and thereby creates an air bearing of relatively small height between the underlying fixed, generally planar support surface and the perforated flexible sheet. Examples of prior art transfer mattresses may be found in U.S. Pat. Nos. 4,054,960; 4,272,856; 4,517,690; 4,627,426; 5,065,464; 5,483,709; RE35,299; U.S. Pat. Nos. 5,561,873; 5,594,962; 5,598,593; 5,742,958; 6,073,291; 6,374,435; 6,415,583; 6,418,579; 6,677,026; 6,684,434; 6,687,935; 6,760,939; 6,857,143; 6,898,809, and published patent application No. 2002/0166168, which patents and applications are incorporated herein by reference.

There is a need in the art for an inflatable mattress that allows for easy positioning of a patient who may still have surgical or therapeutic fixtures or instruments attached to or protruding from their body.

### SUMMARY OF THE INVENTION

The present invention provides an inflatable mattress having a top panel including an annular internal edge that defines a first opening and a bottom panel sealingly assembled to the top panel and having an annular internal edge that defines a second opening. The bottom panel also includes a plurality of perforations wherein the first opening and the second opening together form a portal for accommodating a medical device protruding from a patient.

In an alternative embodiment, an inflatable transfer mattress is provided that includes a top panel having a top surface and an annular internal edge that defines an opening in the top surface. A bottom panel that is sealingly assembled to the top panel has a bottom surface and an annular internal edge that defines an opening in the bottom surface. The bottom panel also defines a plurality of perforations surrounding the opening in the bottom surface. The opening in the top surface aligns with the opening in the bottom surface thereby together forming a portal for accommodating a medical device protruding from a patient when a patient is lying upon the top panel of an inflated transfer mattress.

In another alternative embodiment of the invention, a transfer mattress is provided that includes a top inflatable mattress having a top panel with a first annular internal edge that defines a first opening and a selectable inlet/outlet valve arranged for airflow communication between an interior chamber and a source of pressurized air. A bottom inflatable mattress is separated by a common wall from the top inflatable mattress, and also has a selectable inlet/outlet valve arranged for airflow communication between an interior chamber of the bottom inflatable mattress and a source of pressurized air. The bottom inflatable mattress includes a bottom panel having a plurality of perforations defined therethrough wherein the first opening defines a portal suitable for accommodating a medical device protruding from a patient when a patient is lying upon the top inflatable mattress.

A method is provided for holding a patient for a period of time where the patient has had a medical fixture implanted in a body portion so that a portion of the medical fixture projects outwardly from the patient's body. The method includes positioning an inflatable mattress on a surface suitable for supporting the patient. The inflatable mattress comprises a portal suitable for accommodating the medical fixture that is protruding from the patient. The mattress is inflated, and the patient is positioned on the top of the inflated mattress and arranged so that the projecting portion of the medical fixture is located within the portal.

In another method for holding a patient for a period of time where the patient has had a medical fixture implanted in a body portion so that a portion of the medical fixture projects outwardly from the patient's body, an inflatable mattress is positioned on a surface that is suitable for supporting the patient. The inflatable mattress includes at least one portal suitable for accommodating the medical fixture that is protruding from the patient. The patient is positioned on the inflatable mattress so that the projecting portion of the medical fixture is located adjacent to the portal. The inflatable mattress is then inflated such that the portal provides clearance for accommodating the medical fixture.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts and further wherein:

FIG. 1 is a perspective view of an inflatable transfer mattress including a medical device portal formed in accordance with the present invention;

FIG. 2 is top plan view of the inflatable transfer mattress similar to the one shown in FIG. 1, but having longitudinally oriented internal baffles;

FIG. 3 is a cross-sectional view of the inflatable transfer mattress shown in FIG. 2 as taken along lines 3-3;

FIG. 4 is a cross-sectional view of the inflatable transfer mattress shown in FIG. 2 as taken along lines 4-4;

FIG. 5 is a cross-sectional view of the inflatable transfer mattress shown in FIG. 1, as taken along lines 5-5;

FIG. 6 is a cross-sectional view similar to that shown in FIG. 5, but including a representation of a patient lying atop the inflatable transfer mattress;

FIG. 7 is a top plan view of an inflatable transfer mattress having transversely oriented internal baffles;

FIG. 8 is a cross-sectional view of the inflatable transfer mattress shown in FIG. 7 as taken along lines 8-8;

FIG. 9 is a perspective view of another inflatable transfer mattress formed in accordance with the present invention, including an alternatively shaped medical device portal;

FIG. 10 is a top plan view of the inflatable transfer mattress shown in FIG. 9;

FIG. 11 is a cross-sectional view of the inflatable transfer mattress shown in FIG. 10 as taken along lines 11-11;

FIG. 12 is a broken-away cross-sectional view of the inflatable transfer mattress shown in FIGS. 10 and 11, as taken along lines 11-11, with a patient lying on the mattress;

FIG. 13 is a perspective view of yet another inflatable transfer mattress including a medical device portal formed and positioned in the transfer mattress in accordance with the an alternative embodiment of the present invention;

FIG. 14 is a perspective view of a further inflatable transfer mattress including a medical device portal formed and positioned in the transfer mattress in accordance with the present invention;

FIG. 15 is a perspective view of a dual-chambered transfer mattress formed in accordance with an alternative embodiment of the present invention;

FIG. 16 is a cross-sectional view of the dual-chambered transfer mattress shown in FIG. 15; and

FIG. 17 is a cross-sectional view of the dual-chambered transfer mattress shown in FIG. 16, with the second chamber deflated.

### DETAILED DESCRIPTION OF THE PREFERRED EMBODIMENTS

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. In the claims, means-plus-function clauses, if used, are intended to cover the structures described, suggested, or rendered obvious by the written description or drawings for performing the recited function, including not only structural equivalents but also equivalent structures.

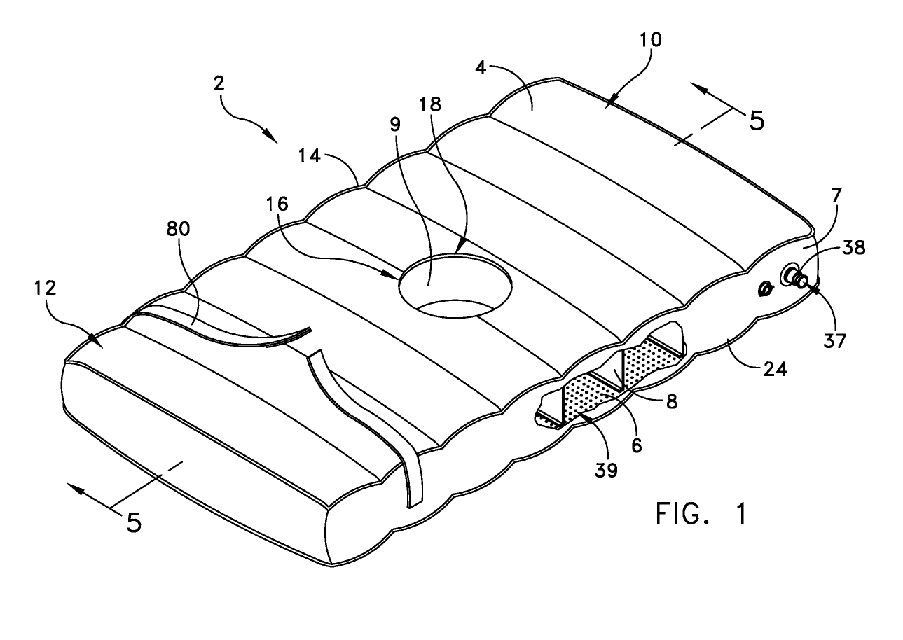

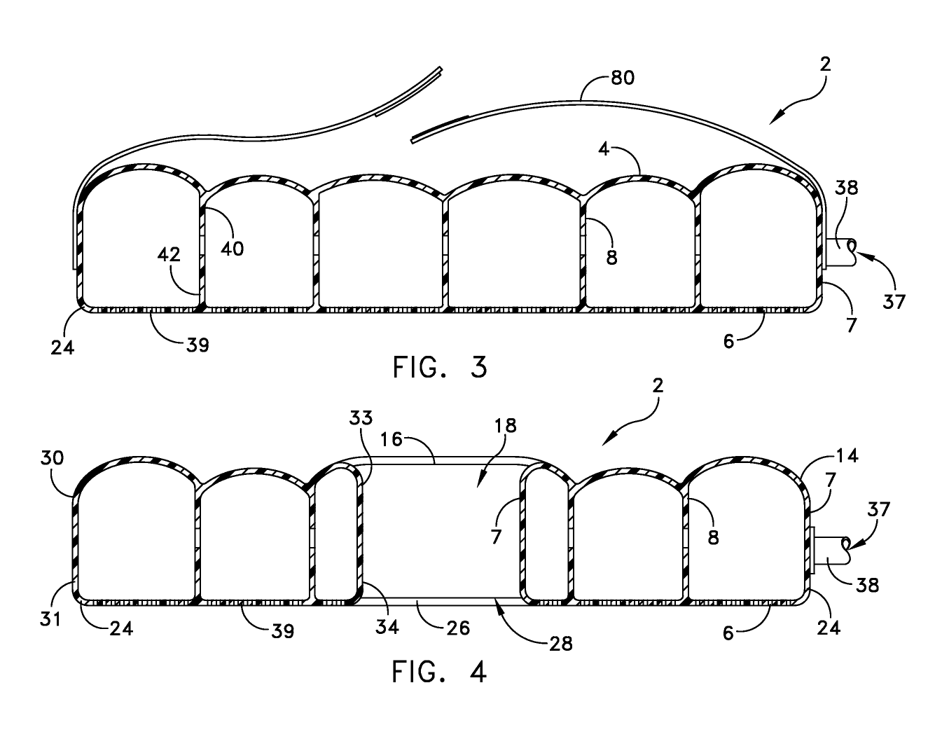

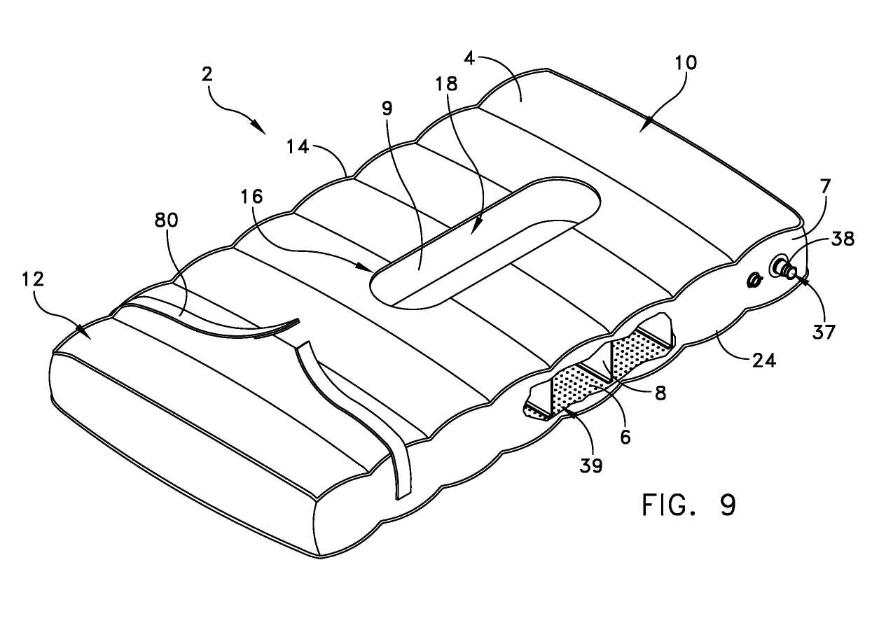

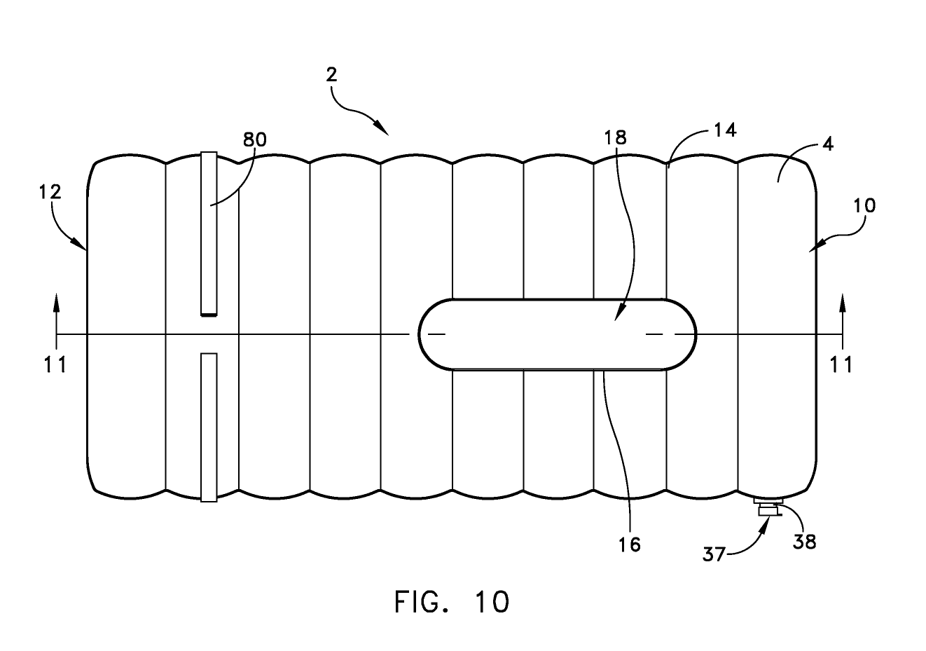

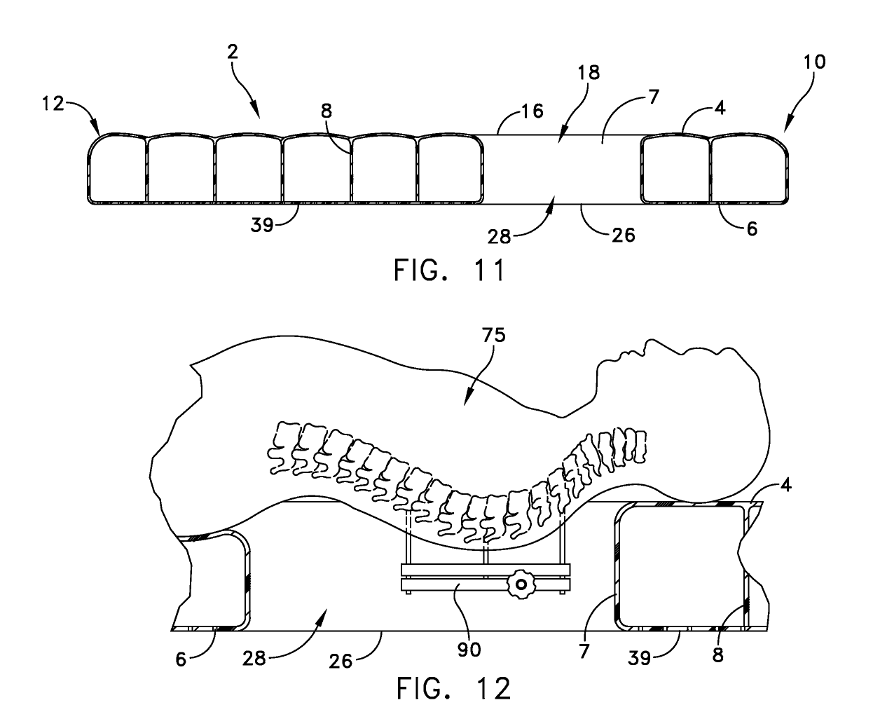

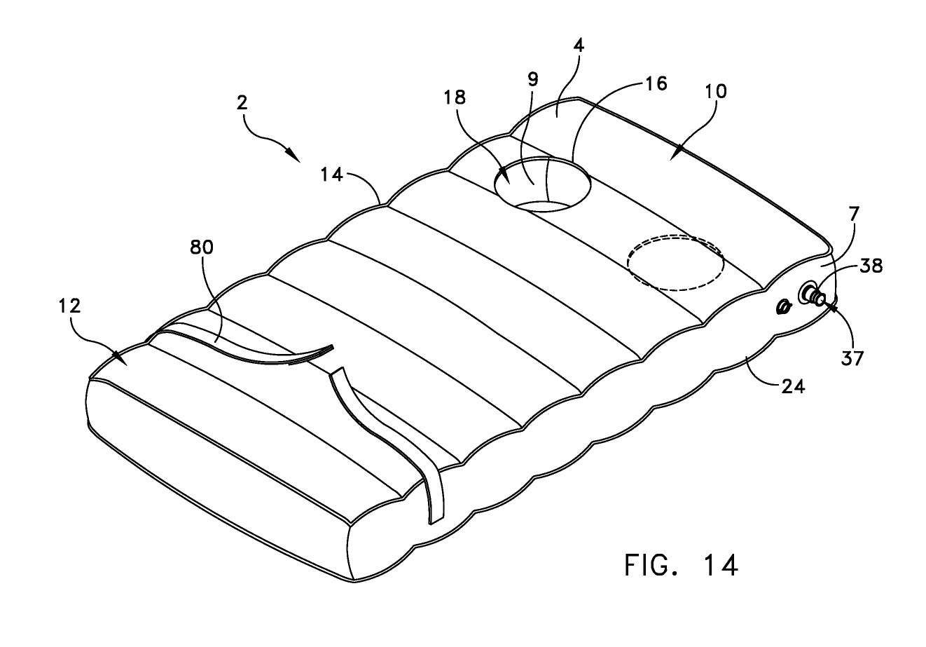

Referring to FIGS. 1-4, an inflatable mattress 2 is provided including a top panel 4, a bottom panel 6, a perimeter band 7, a plurality of baffle-panels 8, and an inner band panel 9. Top panel 4 comprises a head portion 10, a foot portion 12, a peripheral edge 14, and an internal annular edge 16 that defines an opening 18. Likewise, bottom panel 6 comprises a head portion 20, a foot portion 22, a peripheral edge 24, and an internal annular edge 26 that defines an opening 28, and is substantially similar in peripheral profile to top panel 4 (FIGS. 4 and 6). Perimeter band 7 often comprises an elongate substantially rectangular strip, having a top edge 30 and a bottom edge 31. In preferred embodiments of the invention, top panel 4 and bottom panel 6 are substantially the same in size and peripheral outline so that top edge 30 and bottom edge 31 of perimeter band 7 may be sealingly fastened to peripheral edges 14 and 24. Inner band panel 9 includes a top edge 33 and bottom edge 34 that are sealingly fastened to internal annular edges 16 and 26, of top and bottom panels 4 and 6, respectively so as to define a portal through inflatable mattress 2. In addition, openings 18 and 28 communicate with the portal, and may have a wide variety of shapes and locations (FIGS. 1, 9, 10, 13, and 14) dependent upon the particular fixture that is to be accommodated by inflatable mattress 2 (FIGS. 6 and 12).

An inlet opening 37 is formed in a portion of perimeter band 7, between peripheral edges 14 and 24, and may be a closable opening that sealingly accepts an air supply hose 38 (FIG. 1-4). Inlet opening 37 is sized and shaped so that air supply hose 38 may be inserted, with the inlet being thereafter snapped shut or otherwise closed to hold air supply hose 38 in place while inflatable mattress 2 is being inflated. Inlet opening 37 may also include a valve (not shown) that is biased to be normally closed to prevent air from exiting through the inlet, and opened when air supply hose 38 is inserted into inlet opening 37. Other arrangements known to those skilled in the art may be used to inflate inflatable mattress 2.

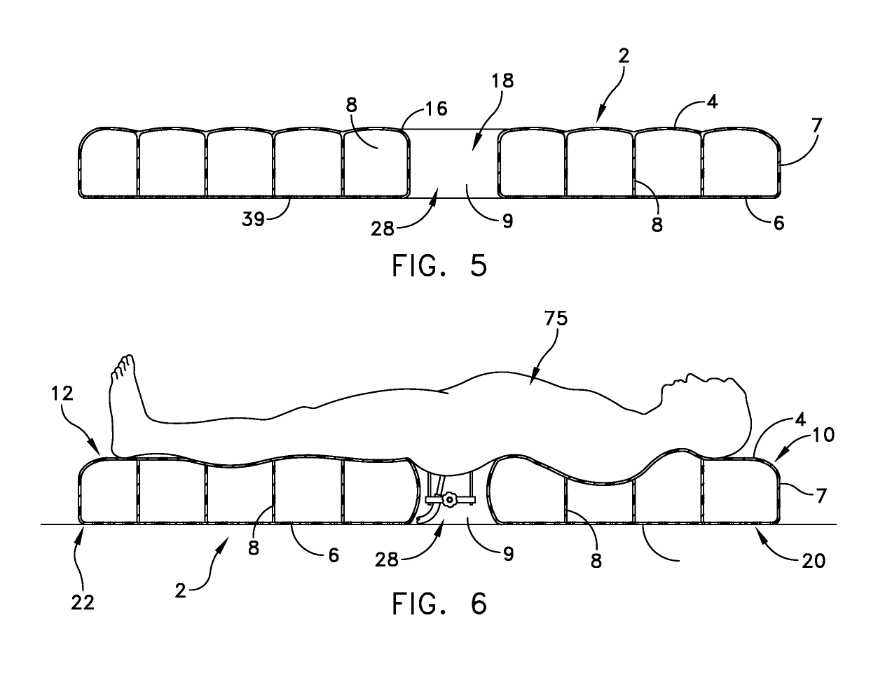

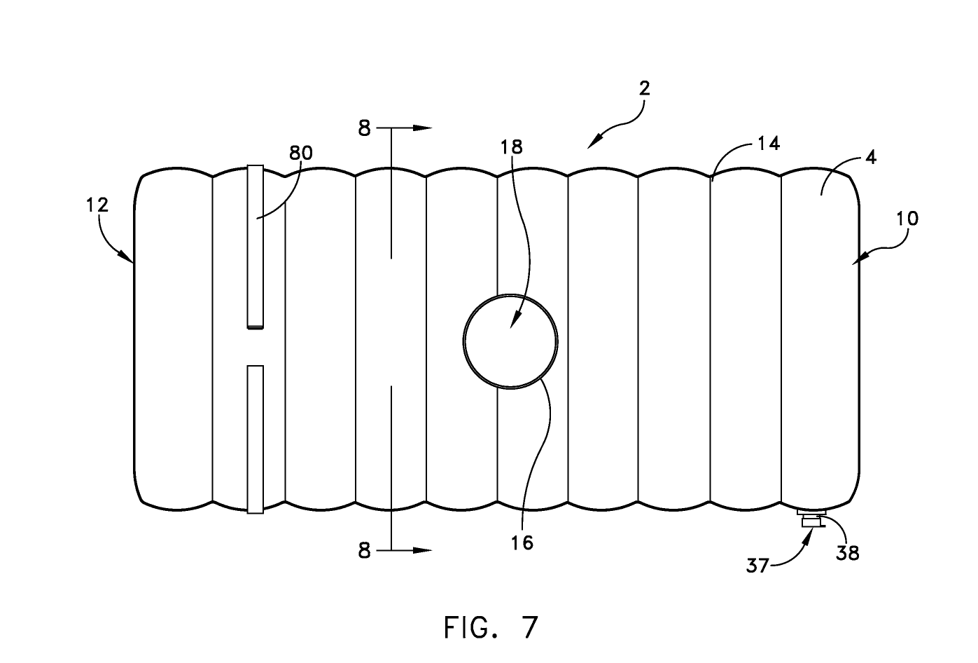

Bottom panel 6 includes a plurality of tiny holes 39 (FIGS. 1 and 3-6) that are defined through its thickness to allow air, that is supplied by a high-pressure air supply to inflatable mattress 2, via air supply hose 38, to escape in a controlled manner so as to allow inflatable mattress 2 to be used as a transfer mattress. The air supplied to a transfer-capable embodiment of inflatable mattress 2 escapes through plurality of holes 39, providing a weight-bearing cushion of air that facilitates the sliding of inflatable mattress 2 along a surface, as well as, from one surface to another.

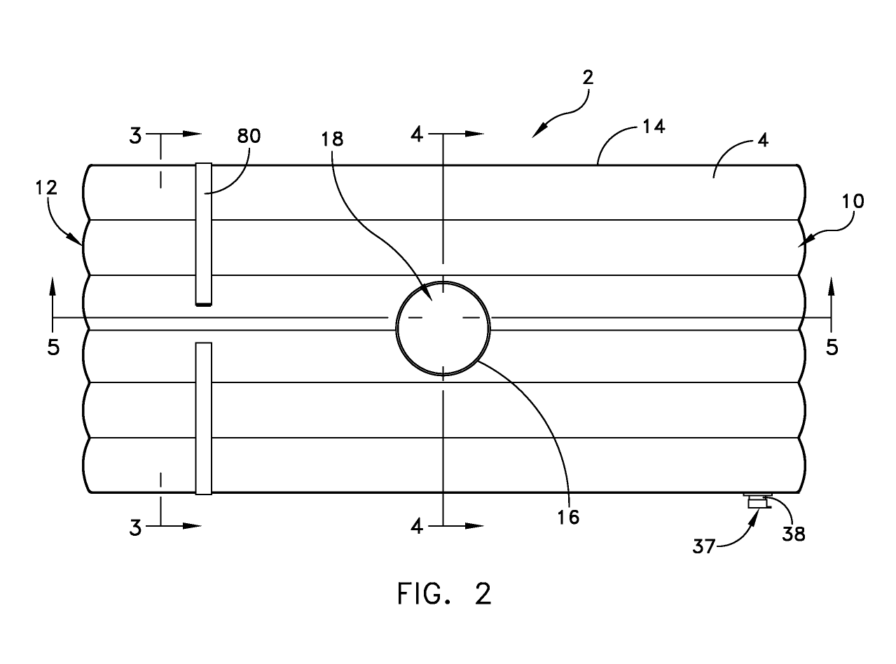

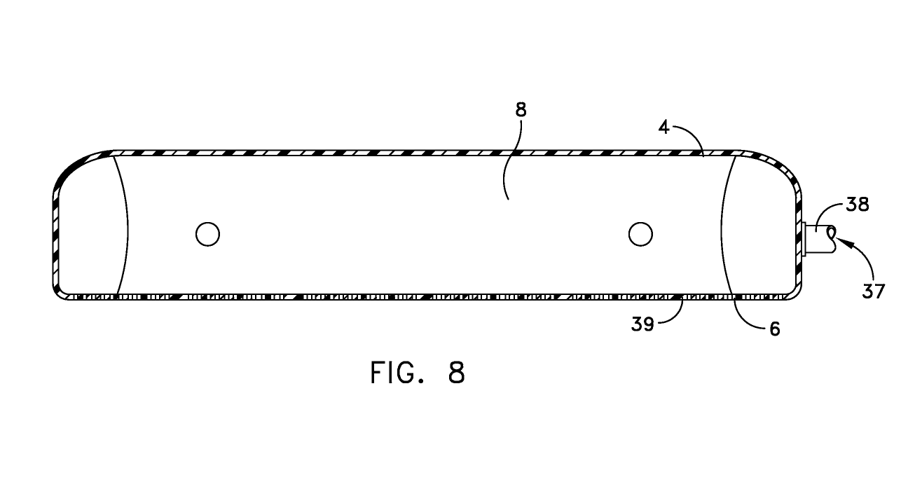

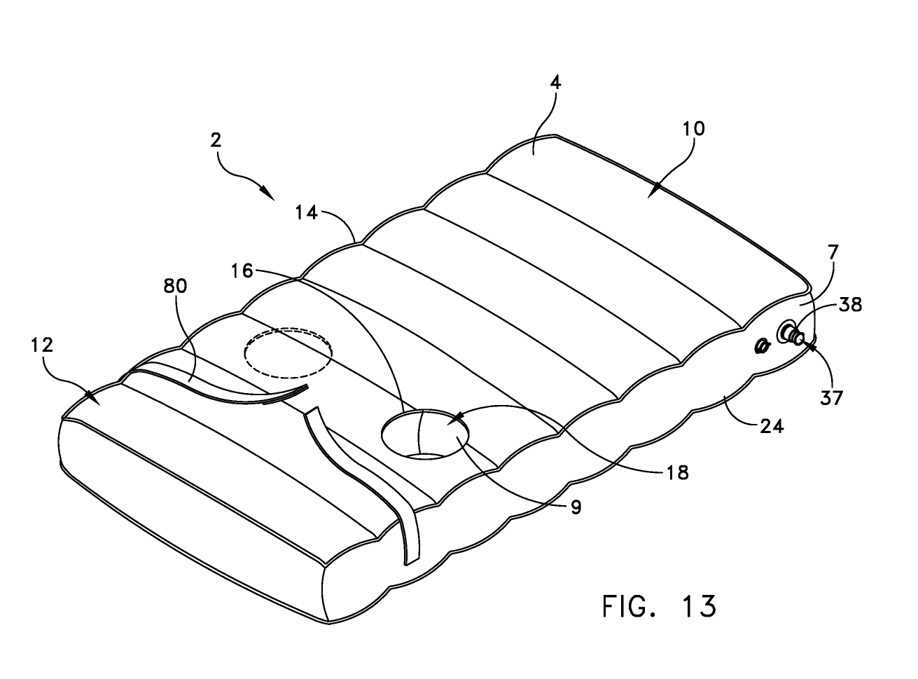

Plurality of baffle-panels 8 each comprise substantially rectangular sheets of nylon scrim or the like, and include a top edge 40 and a bottom edge 42. Baffle-panels 8 may have differing or varying widths, depending upon their position within inflatable mattress 2. Each top edge 40 may be fastened longitudinally (FIGS. 2, 3, and, 4) or transversely (FIGS. 1 and 8-14) to a portion of the inner surface of top panel 4, and each bottom edge 42 may be fastened longitudinally (FIGS. 2, 3, and, 4) or transversely (FIGS. 1 and 8-14) to a portion of the inner surface of bottom panel 6. When baffle panels 8 are assembled in a transverse manner, they may often have a narrow center section that causes at least top panel 4 to form a longitudinally oriented concave recess which helps to cradle a patients legs when inflatable mattress 2 is inflated with air. A similar concave recess is formed when baffle panels 8 are assembled in a longitudinal manner.

Some or all of top panel 4, bottom panel 6, perimeter band 7, plurality of baffle-panels 8, and inner band 9 are most often, but not always formed from a sheet of fabric, e.g., nylon scrim or the like, and may be coated on at least its outer surface with a water proof coating. The water proof coating may be any of the well known polymeric or elastomeric compounds that are known to be impervious to semi-solids and liquids, such as, blood, urine, feces, hospital strength disinfecting compounds, alcohol, or the like. For example, a nylon twill fabric that is coated on one side with a heat sealable, polyurethane coating (e.g., an inner side) and the outer side coated with a Durable Water Repellant (Patient side). A practical benefit associated with the use of the foregoing preferred materials is that inflatable mattress 2 retains a better appearance for longer periods of time during use. A double coated inflatable mattress 2 can be easily wiped down, and can be put back into use more quickly.

Alternatively, in those instances where a single use, single patient mattress is provided, i.e., where patient use lasting less than twenty four hours is desired, some or all of top panel 4, bottom panel 6, perimeter band 7, and plurality of baffle-panels 8 may be formed from fibers for forming fabrics suitable for single use top panel 4 may be made of materials, such as, acetate, acrylic, anidex, aramid, azion, cotton, elastoester, fluorocarbon, fur, glass, lyocell, melamine, metallic, modacrylic, modal, mosacrylic, novoloid, nylon, nytril, olefin, PAN, PBI, PEEK, Pelco, PEN, PLA, PTT, polyester, polyester-polyarylate, rayon, saran, spandex, sulfar, triacetate, vinal, vinyon, and wool. A common characteristic of the foregoing and like materials is their propensity to stain or discolor as a result of contact with blood, urine, feces, hospital strength disinfecting compounds, alcohol, or the like. Additionally, a variety of films may be used to form a single patient, single use transfer mattress 2, for example, copolyester, copolyether, ethylene vinyl acetate, fluorocarbon, polyamide, olefins, polybutylene, polycarbonate, polyester, polystyrene, polyurethane, polyvinyl, alcohol, polyvinyl chloride, polyvinyl fluoride, and polyvinylidene chloride. A practical benefit associated with the use of the foregoing preferred materials is that transfer mattress 2 retains a stained and discolored appearance for longer periods of time after use thereby alerting hospital staff or other care givers that a particular transfer mattress 2 has completed its useful life, and must be discarded.

In one embodiment, some or all of top panel 4, bottom panel 6, perimeter band 7, and plurality of baffle-panels 8 may comprise a cold water soluble partially hydrolyzed polyvinyl alcohol, cold water insoluble hot water disintegrable aliphatic polyester, and minor proportions of processing and performance aids. The aliphatic polyester has a melt temperature above the normal body temperature of a human (37 degrees C.; 98.6 degrees F.) and is present in the resin blend at a concentration sufficient to constitute the continuous phase of the blend, with the polyvinyl alcohol constituting a discontinuous phase of the blend. The aliphatic polyester renders the resin blend, and the partially hydrolyzed polyvinyl alcohol in the blend is cold water insoluble and determines the temperature at which articles formed from the blend will be subject to dissolution in an aqueous bath and subsequent disposal. A practical benefit associated with the use of the foregoing material is that transfer mattress 2 not only retains a stained and discolored appearance for longer periods of time after use, thereby alerting hospital staff or other care givers that a particular transfer mattress 2 has completed its useful life, and must be discarded, but also if an attempt is made to launder the mattress after a single use it disintegrates during the washing process.

An inflatable mattress 2 is assembled according to one embodiment of the present invention in the following manner. Bottom panel 6 is laid out on a suitable support surface so that baffle-panels 8 may be longitudinally or transversely arranged in the center section of the inner surface both in head portion 22. Once in this position, bottom edge 42 of each baffle-panel 8 is fixedly fastened to the inner surface of bottom panel 6. Baffle-panels 8 may be heat sealed along the interface between bottom edge 42 and the inner surface of bottom panel 6 or sewn in a conventional manner. Heat sealing may be done with the application of heat or ultrasonic energy at the edge interface. In this way, a re-solidified interface structure is formed between bottom edge 42 and the inner surface so as to improve the bond and its resistance to rupture under normal loading.

Once plurality of baffle-panels 8 are fastened to the inner surface of bottom panel 6, top panel 4 is arranged in overlying confronting relation with bottom panel 6 so that head portion 12 of top panel 4 is confronting head portion 22 of bottom panel 6, and internal annular edge 16 that defines opening 18 of top panel 4 is in confronting relation to internal annular edge 26 that defines opening 28 of bottom panel 6. Once in this position, each top edge 40 of each baffle-panel 8 is fixedly fastened to the inner surface of top panel 4. One or more perimeter bands 7 are then positioned between peripheral edge 14 of top panel 4 and peripheral edge 24 of bottom panel 6, and then heat sealed along their interface or sewn in a conventional manner. Likewise an inner band 9 is positioned between internal annular edge 16 and internal annular edge 26, and then heat sealed along their interface or sewn in a conventional manner. Here again, heat sealing may be done with the application of heat or ultrasonic energy at the interface between edges. In this way, a re-solidified interface structure is formed so as to improve the bond and its resistance to rupture under normal loading. Alternatively, construction of transfer mattress 2 may be completed by simply sealingly fastening peripheral edge 14 of top panel 4 to peripheral edge 24 of bottom panel 6 and internal annular edge 16 to internal annular edge 26.

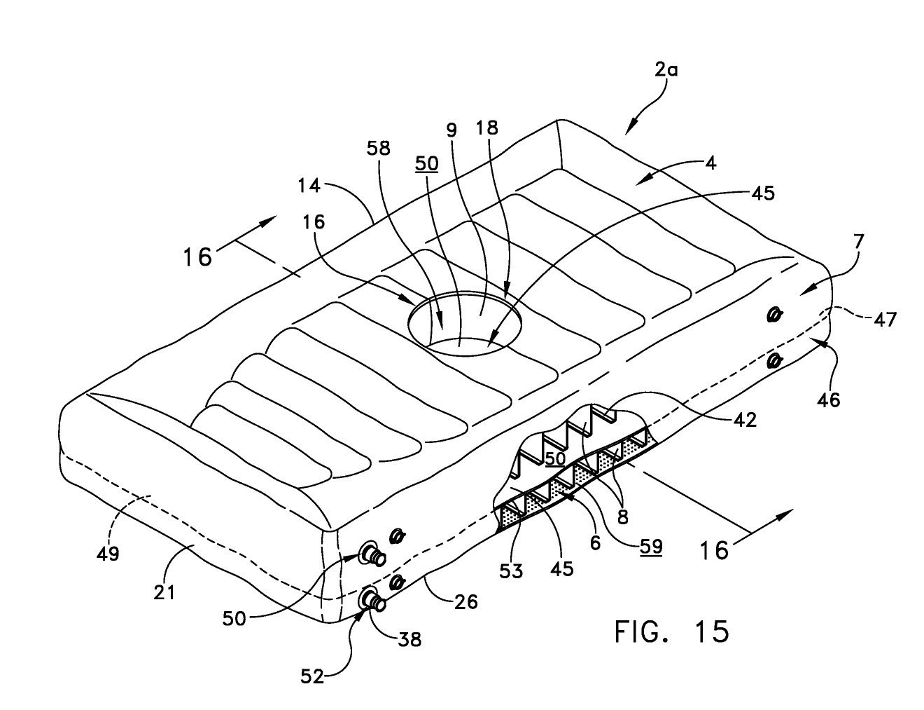

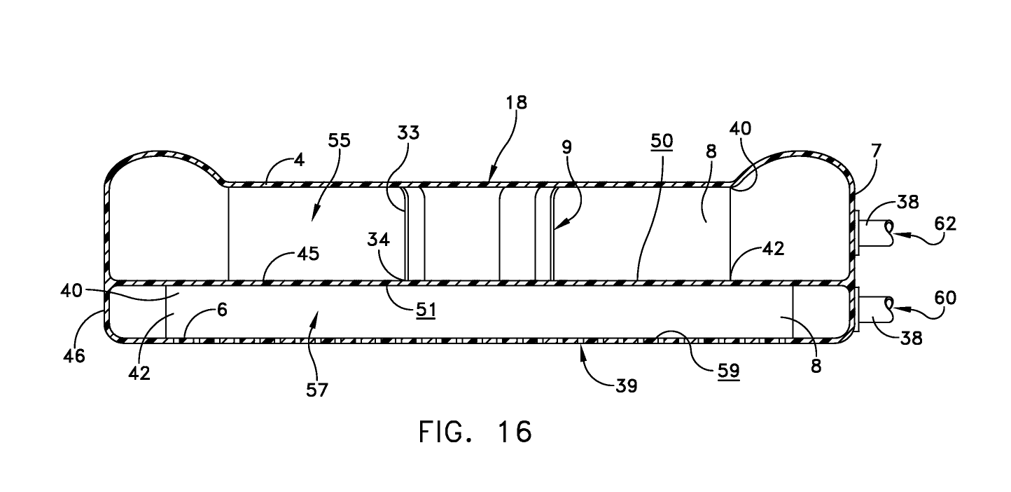

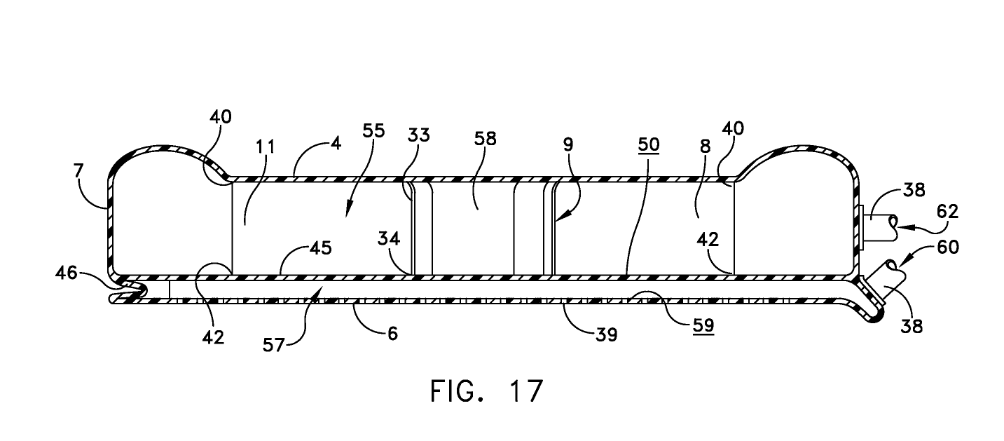

In an alternative embodiment, a dual-chambered, inflatable transfer mattress 2a is provided that is capable of partial deflation so as to allow for a comfortable bed while the transfer features of the invention are not in use. Referring to FIGS. 15-17, dual-chambered transfer mattress 2a includes many of the same structural features as inflatable mattress 2, such as a top panel 4, a bottom panel 6, a top perimeter band 7 and a plurality of baffle-panels 8, which structures comprise substantially the same properties as has been disclosed hereinabove. However, dual-chambered transfer mattress 2a also includes an internal barrier panel 45 and a bottom perimeter band 46 that help define a transfer mattress portion of dual-chambered transfer mattress 2a. Barrier panel 45 comprises a head portion 47, a foot portion 49, a top inner surface 50, a bottom inner surface 51, and a peripheral edge 53, and may be formed from any of the materials disclosed hereinabove.

Bottom panel 6 also includes a plurality of tiny holes 39 that are defined through its thickness to allow air, that is supplied by a high-pressure air supply to dual-chambered transfer mattress 2a, via an air supply hose 38, to escape in a controlled manner. The air supplied to dual-chambered transfer mattress 2a escapes through plurality of holes 39, providing a weight-bearing cushion of air that facilitates the sliding of dual-chambered transfer mattress 2a along a surface, as well as, from one surface to another.

Top perimeter band 7 and a bottom perimeter band 46 often take the form of elongate, rectangular strips of nylon scrim or the like. Top perimeter band 7 is sealingly fastened between peripheral edge 14 of top panel 4 and peripheral edge 53 of barrier panel 45, e.g., by heat sealing, so as to form a first chamber 55. Bottom perimeter band 46 is sealingly fastened between peripheral edge 53 of barrier panel 45 and peripheral edge 24 of bottom panel 6, so as to form a second chamber 57. As with inflatable mattress 2, inner band panel 9 includes a top edge 33 and bottom edge 34 that are sealingly fastened to internal annular edge 16 of top panel 4 and inner surface 50 of barrier panel 45, respectively, so as to define a portal through dual-chambered transfer mattress 2a. In this embodiment, opening 18 defines a blind portal 58, and may have a wide variety of shapes and locations (as shown in FIGS. 1, 9, 10, 13, and 14) dependent upon the particular fixture that is to be accommodated by dual-chambered transfer mattress 2a (FIGS. 6 and 12-17).

Plurality of baffle-panels 8 each comprise substantially rectangular sheets of nylon scrim or the like, and include a top edge 40 and a bottom edge 42. Baffle-panels 8 may have differing widths, depending upon their position within dual-chambered transfer mattress 2a. Two sets of baffle panels 8 are installed within dual-chambered transfer mattress 2a, a first set of baffle panels 8 is located in first chamber 55 and a second set of baffle panels 8 is located in a second chamber 57. For the first set of baffle panels 8, each top edge 40 is fastened transversely to a portion of the inner surface of top panel 4 and each bottom edge 42 is fastened transversely to a portion of the inner surface 50 of barrier panel 45. For the second set of baffle panels 8, each top edge 40 is fastened transversely to a portion of inner surface 51 of barrier panel 45 and each bottom edge 42 is fastened transversely to a portion of inner surface 59 of bottom panel 6.

A pair of inlet/outlet openings 60,62 are formed in perimeter bands 7 and 46, respectively, and may be closable openings that sealingly accepts an air supply hose 38. Inlet openings 60,62 are sized and shaped so that air supply hose 38 may be inserted, with the inlet being thereafter snapped shut or otherwise closed to hold air supply hose 38 in place while dual-chambered transfer mattress 2a is being inflated. Inlet openings 60,62 may also include a valve (not shown) that is biased to be normally closed to prevent air from exiting through the inlet, and opened when air supply hose 38 is inserted into inlet opening 60,62. Other arrangements known to those skilled in the art may be used to dual-chambered transfer mattress 2a.

A dual-chambered transfer mattress 2a is assembled according to the present invention in the following manner. Bottom panel 6 is laid out on a suitable support surface so that second set of baffle-panels 8 may be transversely arranged in the center section of inner surface 59. Once in this position, bottom edge 42 of each baffle-panel 8 is fixedly fastened to inner surface 59 of bottom panel 6. Baffle-panels 8 are advantageously heat sealed along the interface between bottom edge 42 and inner surface 59 of bottom panel 6. This heat sealing may be done with the application of heat or ultra sonic energy at the edge interface. In this way, a re-solidified interface structure is formed so as to improve the bond and its resistance to rupture under normal loading.

Once second set of baffle-panels 8 are fastened to inner surface 59 of bottom panel 6, barrier panel 45 is arranged in overlying confronting relation with bottom panel 6. Once in this position, each top edge 40 of each baffle-panel 8 is fixedly fastened to inner surface 50 of barrier panel 45. At this point in the assembly, top panel 4 is arranged in overlying confronting relation with barrier panel 45. Once in this position, second set of baffle panels 8 may be assembled by fixedly fastening each top edge 40 of each baffle-panel 8 to the inner surface of top panel 4 and each bottom edge 42 of each baffle-panel 8 is fixedly fastened to inner surface 50 of barrier panel 45. Top and bottom perimeter bands 7 and 46 are then sealingly fastened to peripheral edge 14 of top panel 4, peripheral edge 49 of barrier panel 45 and peripheral edge 24 of bottom panel 6 so as to complete construction of dual-chambered transfer mattress 2a.

According to one embodiment of the invention, an inflatable mattress 2 may be used either to transport patients after surgical procedures or for parking patients between therapeutic procedures as follows (FIGS. 6 and 12). With air supply hose 38 positioned within opening 37, high-pressure air is forced into inflatable mattress 2. Inflation of inflatable mattress 2 may be accomplished with or without a patient 75 positioned on outer surface of top panel 4 (FIGS. 6 and 12). With patient 75 in position upon inflatable mattress 2, and prior to inflation, leg straps 80 may be fastened across the outer surface of inflatable mattress 2. In this way, patient 75 retains a sense of security while lying upon inflatable mattress 2 during inflation/deflation. Patient 75 may be placed on inflatable mattress 2 before or after inflating has begun or is completed depending upon whether a surgical fixture 90 has been fitted to a portion of the patient's body.

In accordance with a further embodiment of the invention, dual-chambered transfer mattress 2a may be used when the physical act of positioning or transferring a patient 75 is completed, as follows. Patient 75 is positioned atop the outer surface of dual-chambered transfer mattress 2a so that the patient's head is resting on top panel 4. Dual-chambered transfer mattress 2a is inflated by passing high pressure air through opening 62 in top perimeter band 7. As the high pressure air enters first chamber 55 inflating it. Once first chamber 55 is inflated, high pressure air may be passed through opening 60 in bottom perimeter band 46 so that second chamber 57 is fully inflated, with air flowing through holes 39 so as to effect the cushion of air necessary for transfer of the patient. It will be understood that this sequence of inflation is arbitrary and that either chamber 55 or chamber 57 may be inflated first. With both chambers inflated, dual-chambered transfer mattress 2a is shifted laterally from a gurney or table onto another surface, e.g., a bed or to table in a recovery area of a hospital. Once in this position, inlet/outlet opening 60 is opened so as to allow pressurized air to escape from second chamber 57. As the air escapes second chamber 57, barrier panel 45 moves toward bottom panel 6. Advantageously, air does not escape from first chamber 55 so that the patient is positioned comfortably on top panel 4. Once the recovery period is at an end, air is reintroduced into dual-chambered transfer mattress 2a so as to reinflate second chamber 57. Once second chamber 57 has been inflated with air flowing through holes 39, dual-chambered transfer mattress 2a and the patient may be shifted from the table onto the gurney for removal from the area.

It is to be understood that the present invention is by no means limited only to the particular constructions herein disclosed and shown in the drawings, but also comprises any modifications or equivalents within the scope of the claims.

What is claimed is:

1. An inflatable mattress comprising:
a top panel having a first annular internal edge that defines a first opening;
a bottom panel having a plurality of perforations defined therethrough, and being sealingly assembled to said top panel wherein said bottom panel includes a second annular internal edge that defines a second opening so that said first opening and said second opening together form a portal suitable for accommodating a medical device protruding from a patient when a patient is lying upon said top panel of an inflated transfer mattress.

2. An inflatable mattress according to claim 1 wherein said portal is defined by an inner band panel that extends from said first annular edge to said second annular edge.

3. An inflatable mattress according to claim 1 wherein said portal defines a non-circular opening through said inflatable mattress.

4. An inflatable mattress according to claim 1 wherein said bottom panel defines a plurality of perforations surrounding said second opening thereby forming an inflatable transfer mattress.

5. An inflatable mattress according to claim 4 comprising an access port suitable for communication with a source of pressurized fluid so as to inflate said inflatable mattress.

6. An inflatable mattress according to claim 1 wherein said top panel and said bottom panel are arranged so as to comprise a common peripheral edge.

7. An inflatable mattress according to claim 6 wherein said portal is located adjacent to a portion of said peripheral edge.

8. An inflatable mattress according to claim 1 wherein said top panel and said bottom panel each comprise a peripheral edge that is sealingly engaged with an annular perimeter band so as to define an internal chamber.

9. An inflatable mattress according to claim 8 wherein said portal is defined by an inner band panel that extends from said first annular edge to said second annular edge so as to be substantially parallel to said annular perimeter band.

10. An inflatable mattress according to claim 1 wherein said top panel and said bottom panel are each formed from material selected from the group consisting of acetate, acrylic, anidex, aramid, azlon, cotton, elastoester, fluorocarbon, fur, glass, lyocell, melamine, metallic, modacrylic, modal, mosacrylic, novoloid, nylon, nytril, olefin, PAN, PBI, PEEK, Pelco, PEN, PLA, PTT, polyester, polyester-polyarylate, rayon, saran, spandex, sulfar, triacetate, vinal, vinyon, and wool.

11. An inflatable mattress according to claim 1 wherein said top panel and said bottom panel are each formed from material selected from the group consisting of copolyester, copolyether, ethylene vinyl acetate, fluorocarbon, polyamide, olefins, polybutylene, polycarbonate, polyester, polystyrene, polyurethane, polyvinyl, alcohol, polyvinyl chloride, polyvinyl fluoride, and polyvinylidene chloride.

12. An inflatable transfer mattress comprising:
a top panel having a top surface and an annular internal edge that defines an opening in said top surface;
a bottom panel sealingly assembled to said top panel and having a bottom surface and an annular internal edge that defines an opening in said bottom surface, said bottom panel defining a plurality of perforations surrounding said opening in said bottom surface wherein said opening in said top surface aligns with said opening in said bottom surface thereby together forming a portal for accommodating a medical device protruding from a patient when a patient is lying upon said top panel of an inflated transfer mattress.

13. An inflatable transfer mattress according to claim 12 wherein said portal is defined by an inner band panel that extends from said first annular edge to said second annular edge.

14. An inflatable transfer mattress according to claim 12 wherein said portal defines a non-circular opening through said inflatable mattress.

15. An inflatable transfer mattress according to claim 12 wherein said top panel and said bottom panel are arranged so as to comprise a common peripheral edge.

16. An inflatable transfer mattress according to claim 15 wherein said portal is located adjacent to a portion of said peripheral edge.

17. An inflatable transfer mattress according to claim 12 wherein said top panel and said bottom panel each comprise a peripheral edge that is sealingly engaged with an annular perimeter band so as to define an internal chamber.

18. An inflatable transfer mattress according to claim 17 wherein said portal is defined by an inner band panel that extends from said first annular edge to said second annular edge so as to be substantially parallel to said annular perimeter band.

19. A single use, single patient inflatable mattress comprising:
a top panel formed from a cold water soluble partially hydrolyzed polyvinyl alcohol, cold water insoluble hot water disintegrable aliphatic polyester having a first annular internal edge that defines a first opening;
a bottom panel formed from a cold water soluble partially hydrolyzed polyvinyl alcohol, cold water insoluble hot water disintegrable aliphatic polyester having a plurality of perforations defined therethrough, and being sealingly assembled to said top panel wherein said bottom panel includes a second annular internal edge that defines a second opening so that said first opening and said second opening together form a portal suitable for accommodating a medical device protruding from a patient when a patient is lying upon said top panel of an inflated transfer mattress.

20. A transfer mattress comprising:
a top inflatable mattress including a top panel having a first annular internal edge that defines a first opening and a selectable inlet/outlet valve arranged for airflow communication between an interior chamber and a source of pressurized air; and
a bottom inflatable mattress separated by a common wall from said top inflatable mattress and having a selectable inlet/outlet valve arranged for airflow communication between an interior chamber of said bottom inflatable mattress and a source of pressurized air, said bottom inflatable mattress including a bottom panel having a plurality of perforations defined therethrough wherein said first opening defines a portal suitable for accommodating a medical device protruding from a patient when a patient is lying upon said top panel.

21. An inflatable mattress according to claim 20 wherein said portal is defined by an inner band panel that extends from said first annular edge to said common wall.

22. An inflatable mattress according to claim 20 wherein said portal defines a non-circular opening through said top inflatable mattress.

23. An inflatable mattress according to claim 20 wherein said portal is located adjacent to a peripheral edge of said top inflatable mattress.

24. An inflatable mattress according to claim 21 wherein said portal is defined by an inner band panel that extends from said first annular edge to said common wall so as to be substantially parallel to an annular perimeter band of said top inflatable mattress.

25. An inflatable mattress according to claim 20 wherein said top inflatable mattress and said bottom inflatable mattress are each formed from material selected from the group consisting of acetate, acrylic, anidex, aramid, azlon, cotton, elastoester, fluorocarbon, fur, glass, lyocell, melamine, metallic, modacrylic, modal, mosacrylic, novoloid, nylon, nytril, olefin, PAN, PBI, PEEK, Pelco, PEN, PLA, PTT, polyester, polyester-polyarylate, rayon, Saran, spandex, sulfar, triacetate, vinal, vinyon, and wool.

26. An inflatable mattress according to claim 20 wherein said top inflatable mattress and said bottom inflatable mattress are each formed from material selected from the group consisting of copolyester, copolyether, ethylene vinyl acetate, fluorocarbon, polyamide, olefins, polybutylene, polycarbonate, polyester, polystyrene, polyurethane, polyvinyl, alcohol, polyvinyl chloride, polyvinyl fluoride, and polyvinylidene chloride.

27. A method for holding a patient for a period of time where said patient has had a medical fixture implanted in a body portion so that a portion of said medical fixture projects outwardly from said patient's body comprising:
(A) positioning an inflatable mattress on a surface suitable for supporting a patient wherein said inflatable mattress comprises a portal suitable for accommodating a medical device protruding from a patient when said patient is lying upon said inflated mattress,
(B) inflating said inflatable mattress;
(C) positioning a patient, having a medical fixture implanted in a body portion wherein a portion of said medical fixture projects outwardly from said body portion, on said inflatable mattress so that said projecting portion of said medical device is located within said portal.

28. A method for holding a patient for a period of time where said patient has had a medical fixture implanted in a body portion so that a portion of said medical fixture projects outwardly from said patient's body comprising:
(A) positioning an inflatable mattress on a surface suitable for supporting a patient wherein said inflatable mattress comprises a portal suitable for accommodating a medical device protruding from a patient when said patient is lying upon said inflated mattress.
(B) positioning a patient, having a medical fixture implanted in a body portion wherein a portion of said medical fixture projects outwardly from said body portion, on said inflatable mattress so that said projecting portion of said medical device is located adjacent to said portal;
(C) inflating said inflatable mattress such that said portal provides clearance for accommodating said medical fixture.
